(19) United States
(12) Patent Application Publication
(10) Pub. No.: US 2025/0338076 A1
(43) Pub. Date: Oct. 30, 2025

(54) Audio System with Personal Zones

(71) Applicant: Bose Corporation, Framingham, MA (US)

(72) Inventors: Charles Terence Henry Oswald, Salem, NY (US); Michael S. Dublin, Arlington, MA (US); Michael James Tiene, Concord, NH (US); Rahulram Sridhar, Medford, MA (US)

(21) Appl. No.: 18/650,220

(22) Filed: Apr. 30, 2024

(51) Int. Cl. H04S 7/00

(52) U.S. Cl. CPC H04S 7/303; H04S 2400/01

(57) ABSTRACT

Various implementations include audio systems and approaches for creating personal audio zones. Certain implementations include a system having: a first set of near-field (NF) speakers; a set of sensors for detecting a position of a first user; and a controller coupled with the first set of NF speakers and the set of sensors and configured to adjust an audio output at the set of NF speakers, wherein the controller is configured to maintain spatialization of the audio output to the first user based on detecting at least one of a position change or an orientation change of the first user, and wherein the controller is configured to control the spatialized audio output to the first user with the first set of NF speakers with consideration of isolation to a second listening location.

### TECHNICAL FIELD

This disclosure generally relates to audio systems. More particularly, the disclosure relates to creating personal audio zones in space.

### BACKGROUND

Conventional near-field speakers in spaces such as vehicles, entertainment systems, gaming systems, etc. can provide certain aspects of audio control such as sound stage, center image, and spatialization. However, such conventional systems can be insufficiently responsive to movement by users within an environment and/or incapable of effectively isolating audio output to distinct users. These conventional systems can hinder the user experience.

### SUMMARY

All examples and features mentioned below can be combined in any technically possible way.

Various implementations include systems and approaches for creating personal audio zones in space. Additional implementations include automobile audio systems and related automobiles with personal audio zones.

In some particular aspects, a system includes: a first set of near-field (NF) speakers for providing an audio output to a first listening location; a set of sensors for detecting at least one of a position change or an orientation change of a first user in the first listening location; and a controller coupled with the first set of NF speakers and the set of sensors and configured to adjust the audio output at the set of NF speakers, where the controller is configured to maintain spatialization of the audio output to the first user based on detecting a position and/or orientation change of the first user, wherein the controller is configured to control the spatialized audio output to the first user with the first set of NF speakers with consideration of isolation to a second listening location.

In additional particular aspects, a vehicle audio system includes: a first set of near-field (NF) speakers for providing a first audio output to a first listening location; a set of sensors for detecting at least one of a position or an orientation of a first user in the first listening location; and a controller coupled with the first set of NF speakers and the set of sensors and configured to adjust the audio output at the first set of NF speakers, where the controller is configured to maintain spatialization of the audio output the first user based on detecting at least one of a position change or an orientation change of the first user, and where the controller is configured to control the spatialized audio output to the first user with the first set of NF speakers with consideration of isolation to a second listening location.

In other particular aspects, an audio system includes: a first set of near-field (NF) speakers proximate a first listening location; a second set of NF speakers proximate a second listening location; a set of sensors for detecting at least one of a position or an orientation of at least one user in the first listening location or the second listening location; and a controller coupled with the first set of NF speakers, the second set of NF speakers, and the set of sensors, where the controller is configured to control a spatialized audio output at one or both sets of the NF speakers, and where the spatialized audio output is approximately consistently isolated during movement by a first user at the first listening location.

Implementations may include one of the following features, or any combination thereof.

In some cases, maintaining spatialization of the audio output includes maintaining independent control of an acoustic signal received at a left ear of the first user and an acoustic signal received at a right ear of the first user. In particular implementations, signals sent to the left ear and right ear are independent of the source channel input.

In particular aspects, the audio output is spatialized such that the acoustic signals received at the left ear of the first user and the right ear of the first user create a perceived acoustic source from a virtual location.

In certain implementations, the virtual location is not associated with a location of the first set of NF speakers. In particular examples, the virtual location is not associated with a location of any speakers providing the audio output, such that the virtual location is not aligned with a location of any speaker providing the audio output. In certain examples, interaural control is used to provide the virtual location.

In particular aspects, the controller is configured to control the spatialized audio output to the first user with the first set of NF speakers with consideration of isolation to the second listening location.

In some cases, the audio output is approximately consistently isolated during the position and/or orientation change (also referred to as movement) of the first user. Consistent isolation can include inter-seat isolation, and can also be characterized as consistently attenuated, such that perception from another location (e.g., an adjacent listening location) is minimal to negligible. Consistent isolation can be measured by one or more locations proximate a primary user (e.g., seat) location, and in particular examples, can be considered from the perspective of a second user.

In particular implementations, the consistently isolated audio output is characterized by a difference in perception of the audio output at the second listening location (or another additional listening location), relative to perception of the audio output at the first listening location, by 5 decibels (dB) or more across the listening bandwidth during the position and/or orientation change of the first user. In some examples, the consistently isolated audio output is characterized by a relative difference in perception of the audio output at another (e.g., second) listening location by 10 dB or more across the listening bandwidth during the position and/or orientation change of the first user. In further examples, the consistently isolated audio output is characterized by a relative difference in perception of the audio output at another (e.g., second) listening location by 15 dB or more, or 20 dB or more across the listening bandwidth during the position and/or orientation change of the first user. In particular cases, while a first user changes position and/or orientation, the relative difference in perception of the audio output between the first user and a second user (e.g., in second listening location) remains at least 5 dB, at least 10 dB, at least 15 dB, or at least 20 dB.

In various examples, the audio output frequencies from the NF speakers extends down to approximately 200 Hertz (Hz), In some examples, the audio output from the NF speakers extends down to approximately 100 Hz. According to various examples a range of listening bandwidth of the audio output from the NF speakers may be approximately 100 Hz to approximately 10 kilo-Hz (kHz). In additional particular implementations, audio output from the NF speakers is provided in a range of listening bandwidth of approximately 200 Hz to approximately 4 kHz.

In particular examples, the first set of NF speakers that are proximate the first listening location includes up to approximately 50 NF speakers (i.e., independently driven transducers). This set of up to 50 NF speakers can be used to provide the spatialized audio output to the first listening location. In more particular examples, this set includes: up to approximately 25 NF speakers, or up to approximately 14 NF speakers, or up to approximately 13 NF speakers, or up to approximately 12 NF speakers, up to approximately 11 NF speakers, or up to approximately 10 NF speakers, or up to approximately 9 NF speakers, or up to approximately 8 NF speakers, or up to approximately 7 NF speakers, or up to approximately 6 NF speakers, or up to approximately 5 NF speakers, or up to approximately 4 NF speakers, or up to approximately 3 NF speakers.

In some cases, the audio output produces a sound stage that is perceived as being in front of the first user. In particular aspects, the sound stage includes a center image. In further aspects, the sound stage perceived as being in front of the first user is aligned with or forward of the first user's eye position, and in certain cases, can be approximately eye level +/−approximately 89 degrees or less. In particular implementations, the sound stage perceived as being in front of the user is perceived as being located approximately forward of the first user's ears. In additional implementations, the sound stage at least partially envelops the first user.

In some examples, the audio output includes full bandwidth audio output.

In particular cases, a set of additional speakers provide a low frequency portion of the audio output. These additional speakers can act as a bass source for the audio output. In certain examples, the additional speakers are located in the far field.

In particular cases, the position and/or orientation change of the first user includes at least one of: head movement, head rotation, body movement, or seat movement, and the controller maintains the full bandwidth audio output while the head rotation of the first user deviates from center by up to approximately 40 degrees. Examples of body movement can include slouching, straightening the back, shifting in the seat, shoulder roll, and/or shoulder rotation. Examples of seat movement can include seat fore/aft movement, seat up/down movement, seatback tilt, and/or headrest height adjustment. Movement and/or rotation can be measured from a reference such as a user in a seat looking straight ahead.

In some aspects, the controller includes a dynamic array module configured to adjust at least one of: isolation of the audio output to the first user or audio performance of the audio output to the first user. In certain cases, there is a tradeoff between isolation of the audio output as compared with audio performance, and in more particular cases, isolation is inversely related to the audio performance.

In various examples, the first set of NF speakers include speakers in a headrest of a seat behind the user. In further examples, the first set of NF speakers include speakers in a headliner of a vehicle cabin.

In some aspects, the first set of NF speakers includes at least two NF speaker elements.

In particular cases, the first set of NF speakers includes at least four NF speaker elements.

In some aspects, the first set of NF speakers includes at least eight NF speaker elements.

In certain cases, the set of sensors includes at least two position and/or orientation sensors.

In particular implementations, the set of sensors includes at least two optical sensors. In one example, the two or more optical sensors include two or more cameras.

In some cases, the controller is configured to provide the audio output from a first audio source and provide a second audio output to a second user at the second listening location from a second audio source.

In certain aspects, the controller is further configured to maintain isolation of the second audio output during a position and/or orientation change of the second user.

In particular cases, the controller is configured to control a stability of the audio output such that a perceived acoustic source from a virtual location is fixed relative to the system throughout the position change and/or orientation change of the user.

In some aspects, the spatialization of the audio output is maintained during a range of position and/or orientation changes for the first user such that for the left ear of the first user and the right ear of the first user: i) in a first position and/or orientation, an acoustic signal received at the left ear arrives earlier than an acoustic signal received at the right ear, ii) in a second position and/or orientation, the acoustic signal received at the left ear arrives at approximately the same time as the acoustic signal received at the right ear, and iii) in a third position and/or orientation, the acoustic signal received at the left ear arrives earlier than the acoustic signal received at the right ear, relative to the first position and/or orientation.

In particular cases, the spatialized audio output creates a perceived acoustic source from a virtual location that is forward and left-of-center of the first user, where the virtual location is not associated with a location of the first set of NF speakers.

In some aspects, in the first position and/or orientation, the acoustic signal received at the left ear has more high frequency content than the acoustic signal received at the right ear, in the second position and/or orientation, the acoustic signal received at the left ear has approximately equal frequency content as the acoustic signal received at the right ear, and in the third position, the acoustic signal received at the left ear has more high frequency content than the acoustic signal received at the right ear, relative to the first position and/or orientation.

In particular cases, the spatialization of the audio output is maintained during a range of position and/or orientation changes for the first user such that for the left ear of the first user and the right ear of the first user: i) in a first position, an acoustic signal received at the right ear arrives earlier than an acoustic signal received at the left ear, ii) in a second position, the acoustic signal received at the left ear arrives at approximately the same time as the acoustic signal received at the right ear, and iii) in a third position, the acoustic signal received at the right ear arrives earlier than the acoustic signal received at the left ear, relative to the first position and/or orientation.

In some aspects, the spatialized audio output creates a perceived acoustic source from a virtual location that is forward and right-of-center of the first user, where the virtual location is not associated with a location of the first set of NF speakers.

In certain cases, in the first position and/or orientation, the acoustic signal received at the right ear has more high frequency content than the acoustic signal received at the left ear, in the second position and/or orientation, the acoustic signal received at the left ear has approximately equal frequency content as the acoustic signal received at the right ear, and in the third position and/or orientation, the acoustic signal received at the right ear has more high frequency content than the acoustic signal received at the left ear, relative to the first position and/or orientation.

In some aspects, the first user is located in a first listening location, and the set of sensors are further configured to detect a position and/or orientation of a second user in a second listening location.

In particular cases, a vehicle includes the system, and the first user is located in a first listening location in the vehicle.

In some examples, the vehicle further includes a second listening location for a second user.

In certain examples, the first listening location includes a vehicle seat having a headrest portion, wherein the first set of NF speakers are located in the headrest portion.

In particular implementations, maintaining spatialization of the audio output includes maintaining independent control of an acoustic signal received at a left ear of the first user and an acoustic signal received at a right ear of the first user. In various aspects, signals sent to the ears of the first user are independent of the source channel input.

In some cases, the audio output is spatialized such that the acoustic signals received at the left ear of the first user and the right ear of the first user create a perceived acoustic source from a virtual location.

In certain examples, a vehicle includes the audio system. In some cases, the first listening location includes a first seat in the vehicle and the second listening location includes a second seat in the vehicle. In particular aspects, the first listening location includes a primary seat and the second listening location includes a secondary seat. In some examples, the primary seat includes a driver's seat in the vehicle. In other examples, the primary seat includes a first listening location in the vehicle.

In some cases, an entertainment system includes the audio system.

In particular aspects, a gaming system includes the audio system.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a schematic depiction of a system including near-field speakers and a set of sensors, according to various disclosed implementations.

FIG. 2 is a side view of a seat in the system of FIG. 1 according to various implementations.

FIG. 3 is schematic block diagram illustrating aspects of near-field speakers proximate a user according to various implementations.

FIG. 4 is data flow diagram illustrating aspects of a controller for spatializing audio output according to various implementations.

FIG. 5 shows a schematic comparison of a first virtual location of audio output responding to user position and/or orientation changes according to various implementations.

FIG. 6 shows a schematic comparison of a second virtual location of audio output responding to user position and/or orientation changes according to various implementations.

FIG. 7 shows a range of virtual locations produced by a system according to various implementations.

FIG. 8 is a schematic depiction of a system including multiple listening locations, near-field speakers, and sensors for providing spatialized audio according to various implementations.

FIG. 9 is a data flow diagram illustrating aspects of a controller for spatializing audio output in a multi-seat configuration according to various implementations.

FIG. 10 illustrates another example data flow diagram illustrating aspects of a controller for spatializing audio output in a multi-seat configuration according to various implementations.

FIG. 11 is a schematic depiction of an additional implementation of a seat for use in a system according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that creating personal audio zones in an environment, such as a vehicle or cabin, can enhance individual user experiences, and in further cases, a group experience. The systems and approaches disclosed use position and/or orientation sensors to detect movement by one or more users and a controller to maintain spatialization of audio output to a user (e.g., a first user) based on the detected position and/or orientation change. In various implementations, the system maintains the spatialized audio output using near-field (NF) speakers. In particular examples, the audio output is spatialized such that acoustic signals received at the left ear and right ear of the user create a perceived acoustic source from a virtual location, e.g., a location not associated with a location of the NF speakers. While the term “speaker” is used in many cases herein, it is understood that a speaker such as a NF speaker can include a plurality of speaker elements such as a set or array of speakers.

In particular implementations, the disclosed NF speakers operate in the audible range to provide an output to a user in a listening location (or multiple users in multiple listening locations) according to prescribed approaches. This audible range can also be referred to as the audible band. In these cases, the audible range output does not rely on ultrasonic energy that is demodulated (otherwise referred to as a nonlinear mix) to provide spatialized audio to the user(s). The disclosed approaches can differ from (and improve upon) conventional approaches that rely on output from transducers outside of the audible range (e.g., in the ultrasonic range). The use of ultrasonics in the conventional approaches can be inefficient, costly, and/or unsafe for users. In contrast to these conventional approaches, the disclosed NF speakers control spatialized audio output (in the audible range) to a first user with the first set of NF speakers with consideration of isolation to a second listening location.

In certain implementations, the disclosed systems and approaches utilize NF speakers in a headrest or backrest portion of a seat to provide a spatialized audio output. In further implementations, the disclosed systems and approaches utilize one or more overhead NF speakers to provide a spatialized audio output. In certain examples, the overhead NF speakers can be mounted in an overhead element such as a roof, vehicle headliner, or overhang (such as a seat overhang). Additional NF speakers can be used to provide the spatialized audio output to a listening location, for example, NF speakers in a pillar or any structure in the vehicle, e.g., the A-pillar, B-pillar, etc.

In certain implementations, as noted herein NF speakers in the pillar locations (e.g., A-pillar or B-pillar) may be beneficially employed to control (e.g., mitigate) acoustic reflections from the sides of a space such as the sides of a vehicle (e.g., window). For example, the system can control output from a NF speaker proximate the A-pillar and/or B-pillar to mitigate acoustic reflections from a window, door, or wall of a vehicle.

Certain example implementations are described as being applicable to seats such as those found in vehicles (e.g., as cars, trains, buses, planes, boats or ships) but can be applicable to the provision of spatialized audio output in other seating arrangements such as entertainment systems and gaming systems, among others. Further, the implementations can be applicable to provision of spatialized audio output in spaces in which a person may sit or stand, including and not limited to, phone booths, elevators, movie theaters, etc.

While this disclosure provides an architecture for providing personal zones, an exhaustive description of systems such as vehicle audio systems that can employ these approaches is omitted for brevity purposes. To the extent necessary, illustrative vehicle audio systems are for example described in U.S. Pat. No. 9,913,065 (issued to Bose Corporation on Mar. 6, 2018), U.S. Pat. No. 9,967,692 (issued to Bose Corporation on May 8, 2018), and U.S. Pat. No. 10,056,068 (issued to Bose Corporation on Aug. 21, 2018), the entire contents of each of which are hereby incorporated by reference. Further, various aspects of the disclosure provide an architecture for detecting movement by one or more users in a seat in order to maintain a spatialized audio output. Examples of systems for detecting user movement in a seat are described in U.S. patent application Ser. No. 17/986,007 (filed Nov. 14, 2022), U.S. patent application Ser. No. 17/837,482 (filed Jun. 10, 2022), and U.S. Pat. No. 11,376,991 (Ser. No. 16/916,308, filed Jun. 30, 2020 and issued on Jul. 5, 2022), the entire contents of each of which are hereby incorporated by reference.

Commonly labeled components in the FIGURES are considered to be substantially equivalent components for the purposes of illustration, and redundant discussion of those components is omitted for clarity.

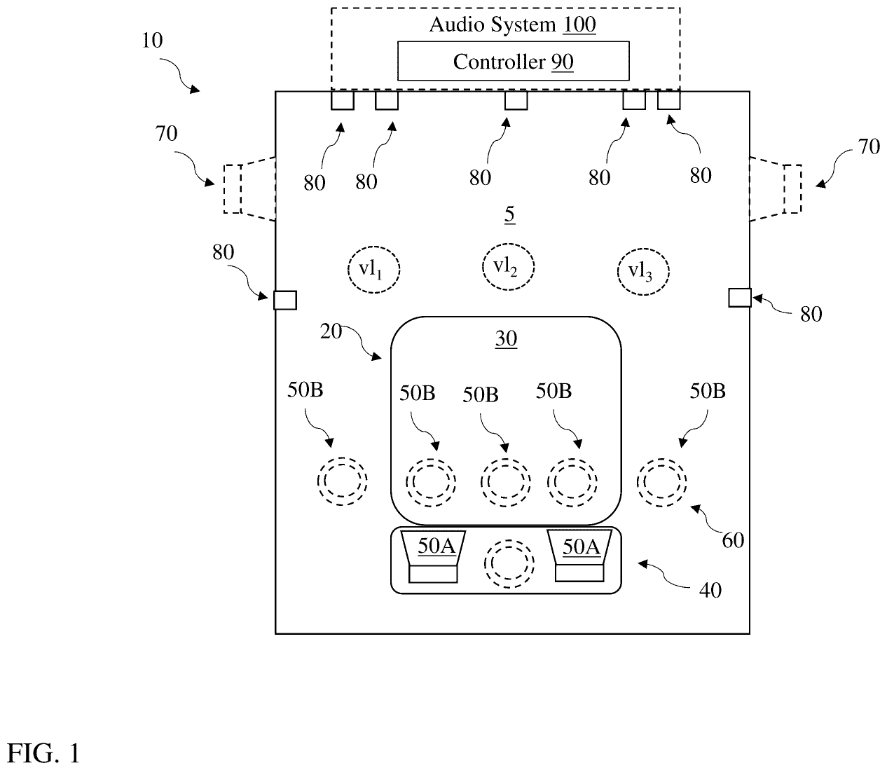

FIG. 1 shows an example of a space 5 including a system 10 including a set of devices according to various implementations. In various implementations, the devices shown in system 10 include a vehicle audio system, an entertainment audio system, a gaming audio system, etc. In certain aspects, the system 10 is located in or around space 5, e.g., a vehicle cabin. In some cases, the space 5 has multiple walls and a ceiling. In particular cases, the space 5 includes the cabin of a vehicle such as a passenger vehicle (e.g., sedan, sport utility vehicle, pickup truck, etc.), a public transit vehicle such as a train, bus or ferry boat, an airplane, a ride-sharing vehicle, etc. Certain example implementations benefit from usage in a vehicle having a number of listening locations, e.g., two or more listening locations in a passenger vehicle or public transit vehicle. However, as noted herein, various implementations provide benefits to a single user and/or a single listening location. As used herein, listening locations can include seating locations, e.g., associated with a seat such as a vehicle seat, gaming seat, entertainment space seat, etc., in additional implementations, listening locations can include a standing location, or a location in space that is intended for a user to stand, sit, etc.

In additional particular implementations, the system 10 can be part of an entertainment system such as a home entertainment system, concert venue, or movie theater. As described herein, the system 10 can enable various spatialized audio control functions that can be beneficially deployed in an entertainment system, e.g., by one or more users. In further implementations, the system 10 is part of a gaming system. As described herein, the system 10 can enable various spatialized audio control functions that can be beneficially deployed in a gaming system, e.g., by one or more users.

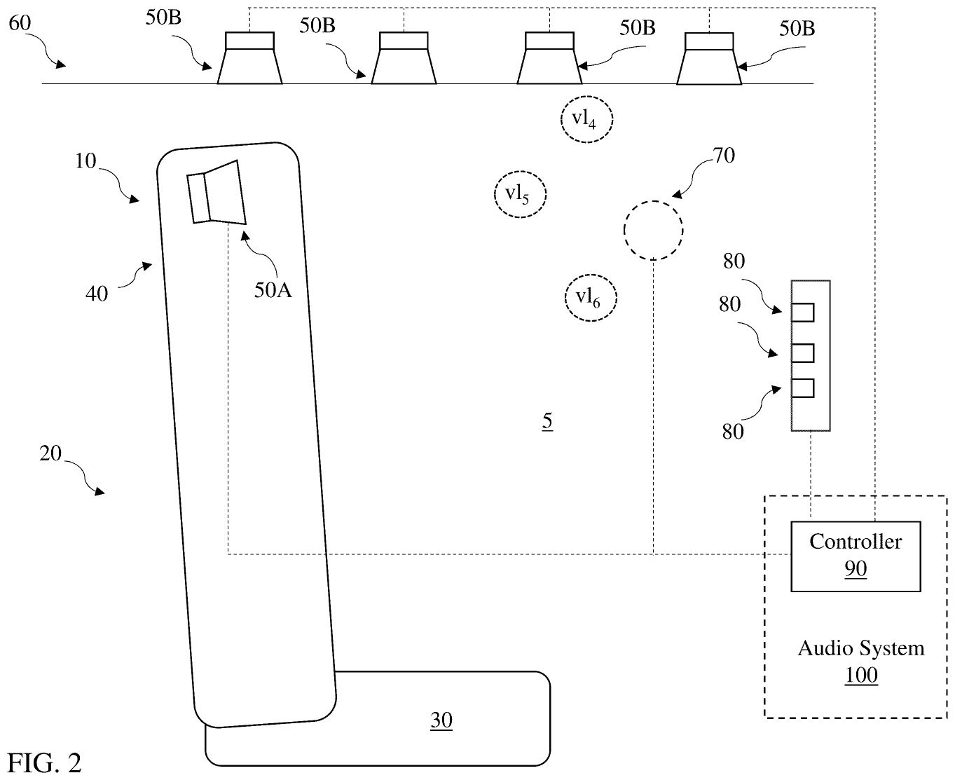

FIG. 2 shows a side view of the space 5 in FIG. 1 according to certain implementations. A seat 20 is shown in the space 5, including a base 30 and a seatback 40, which can be separate components, or integral in certain cases. It is understood that the seatback 40 can include a headrest, which may be integral to the seat 20 and/or removable/adjustable relative to the seat 20. In various implementations, the headrest sits behind the user's head while in the seat 20. In certain cases, the headrest at least partially wraps around the user's head while in the seat, although this is not necessary. As shown in FIGS. 1 and 2, the system 10 can include a first set of NF speakers 50, which in some cases, includes two or more NF speakers 50. Certain NF speakers 50A are mounted in the seatback 40 and/or headrest associated therewith, and certain other NF speakers 50B are mounted in an overhead feature 60. In certain cases, the overhead feature 60 includes a headliner or ceiling. In further implementations, the overhead feature 60 can include an overhang from the seat 20, e.g., a portion of the seat 20 such as the seatback 40 that wraps over the user's head while in the seat 20. In any case, the NF speakers 50 are positioned within the near-field relative to the user's ears, e.g., up to approximately 60 centimeters (cm) from the user's ears within a range of conventional seating positions. In additional examples, the NF speakers 20 are positioned up to approximately 70 cm, 80 cm, or 90 cm from the user's ears within a range of conventional seating positions. In some of these cases, the NF speakers 50A are closer to the user's ears than NF speakers 50B. In other cases, all NF speakers 50 are approximately equidistant from the user's ears. In particular examples, the NF speakers 50A in the seatback 40 remain approximately equidistant to the user's ears during a position and/or orientation change in the seat (e.g., adjusting the seatback 40 relative to the base 30), while the distance between the NF speakers 50B in the overhead feature 60 varies with a position and/or orientation change of the seatback 40. In particular cases, at least one of the NF speakers 50 is up to approximately 50 cm from the user's ear, up to approximately 40 cm from the user's ear, or up to approximately 30 cm from the user's ear. These example near-field ranges are merely illustrative, and various form factors can be considered within one or more of the example ranges of near field as noted herein. In various examples, the NF speakers 50 include at least two total speaker elements (e.g., drivers). In further examples, the NF speakers 50 include at least four total speaker elements (e.g., drivers). In still further examples, the NF speakers 50 include at least eight total speaker elements (e.g., drivers).

In certain cases, one or more microphones (e.g., an array of microphones) is positioned proximate a NF speaker 50, e.g., to enable detection of acoustic signals in the user's near field. Microphones can be part of the sensors 80 shown and described herein, and/or can be positioned with or near NF speakers 50. In particular cases, microphones positioned proximate the NF speaker 50 can be separately housed from the NF speaker(s) 50. In other cases, microphones can be collectively housed with the NF speaker(s) 50. In various implementations, microphones positioned proximate (e.g., within several centimeters up to approximately ten centimeters) the NF speaker 50 can provide feedback and/or feedforward functions in a noise cancelation system and/or spatialization system described herein.

In particular examples, the first set of NF speakers 50 that are proximate the first listening location (e.g., seat 20) includes up to approximately 50 NF speakers (i.e., independently driven transducers). This set of up to 50 NF speakers can be used to provide the spatialized audio output to the first listening location. In more particular examples, this set includes: up to approximately 25 NF speakers, or up to approximately 14 NF speakers, or up to approximately 13 NF speakers, or up to approximately 12 NF speakers, up to approximately 11 NF speakers, or up to approximately 10 NF speakers, or up to approximately 9 NF speakers, or up to approximately 8 NF speakers, or up to approximately 7 NF speakers, or up to approximately 6 NF speakers, or up to approximately 5 NF speakers, or up to approximately 4 NF speakers, or up to approximately 3 NF speakers. In some cases, a similar or distinct number of NF speakers can be used to spatialize audio output at a second (or additional) listening location.

In certain optional cases, the system can include further speakers 70, such as wall-mounted, cab-mounted or door-mounted speakers 70. In particular cases, speakers 70 are outside of the near-field range relative to a first user in the seat 20. In particular cases, the speakers 70 are approximately 100 cm or more from the user's ears while in the seat 20. In further implementations, speakers for providing audio output can be located outside of the near-field range and positioned in the seat base 30, seat back 40, and/or portions of the overhead feature 60. In certain cases, additional speakers such as speakers 70 and/or other speakers outside of the near-field range can provide a low frequency portion of the audio output. These additional speakers can act as a bass source for the audio output. In certain examples, the additional speakers are located in the far field.

In various implementations, the system 10 further includes a set of sensors 80 for detecting a position and/or orientation of a first user, e.g., a user in the seat 20. In certain cases, the position and/or orientation sensors include at least one position and/or orientation sensor (or simply, sensor) 80 for detecting a position and/or orientation of a first user in the seat 20. In some cases, at least two sensors 80 are used to detect the position and/or orientation of the first user in the seat 20. Several sensors 80 are shown in FIGS. 1 and 2 in a non-limiting example. In particular aspects, the (position and/or orientation) sensors 80 include optical sensors such as one or more cameras (or arrays of cameras). Other sensors 80 can also be used as part of the system, e.g., infrared sensors, acoustic sensors, electromagnetic sensors (e.g., including capacitive sensors), etc. Further, position and/or orientation sensors such as motion sensors, pressure sensors, etc. can be integrated into the seat 20 to aid in determination of the position of the user. Additionally, seat position and/or orientation indicators can be integrated into the seat 20 to aid in determination of the position of the user 20 in various implementations, e.g., as described in U.S. patent application Ser. No. 17/986,007 (incorporated by reference herein above).

In particular implementations, sensors 80 can provide position and/or orientation data about the user in a listening location, e.g., in a seat 20. These sensors 80 can provide data about a three-dimensional position of the user, and/or an orientation of the user, in particular, the user's head. For example, the sensors 80 can provide data that indicates a position of a center of the user's head, and in certain cases, also provides a look direction of the user's head. In further cases, the sensors 80 are configured to detect and/or quantify yaw, pitch, and/or tilt of a user's head.

The system 10 can also include a controller 90 coupled with the NF speakers 50 and the sensors 80. The controller 90 is configured to adjust an audio output at the set of NF speakers 50 according to various approaches described herein. In certain optional examples, the controller 90 is part of an audio system 100, such as an entertainment audio system, gaming audio system, or vehicle audio system. In some cases, the audio system 100 includes a communication (comm.) unit coupled with the controller 90, with the comm. unit including a Bluetooth module (e.g., including a Bluetooth radio) or similar communication module, enabling communication with other devices over Bluetooth protocol or similar communication protocol. In certain example implementations, audio system 100 can also include one or more microphones (mic(s)) (e.g., a single microphone or a microphone array). In some cases, the audio system 100 is coupled with at least one speaker (e.g., at least one electro-acoustic transducer) such as speakers 50, 70 for providing an audio output. The audio system 100 can also include additional electronics, such as a power manager and/or power source (e.g., battery or power connector), memory, sensors (e.g., inertial measurement units (IMUs), accelerometers/gyroscope/magnetometers, optical sensors, voice activity detection systems), etc. In some cases, the memory may include a flash memory and/or non-volatile random access memory (NVRAM). In particular cases, memory stores: a microcode of a program for processing and controlling the controller 90 and a variety of reference data (e.g., head related transfer functions (HRTFs) and/or other stored filters); data generated during execution of any of the variety of programs performed by the controller 90; a Bluetooth connection process; and/or various updateable data for safekeeping such as paired device data, connection data, device contact information, etc. Certain of the above-noted components depicted in FIGS. 1 and 2 are optional, and are displayed in phantom. Dashed lines between the controller 90 and speakers 50, 70 and/or sensors 80 in FIG. 2 are merely illustrative, and can represent wireless and/or hard-wired connections between these components. Additional connections may not be shown for simplicity of illustration.

In certain cases, the controller 90 can include one or more microcontrollers or processors having a digital signal processor (DSP). In some cases, the controller 90 is referred to as control circuit(s). The controller(s) 90 may be implemented as a chipset of chips that include separate and multiple analog and digital processors. The controller 90 may provide, for example, for coordination of other components of the audio system 100, such as control of user interfaces (not shown) and applications run by the audio system 100. In various implementations, controller 90 includes a spatialized audio control module (or modules), which can include software and/or hardware for performing audio control processes described herein. For example, controller 90 can include a spatialized audio control module in the form of a software stack having instructions for controlling functions in outputting audio to one or more speakers (e.g., NF speakers 50) in the system 10 according to any implementation described herein. As described herein, the controller 90, as well as other controller(s) described herein, is configured to control functions in a dynamic spatialized approach according to various implementations.

The communication unit in the audio system 100 can include a BT module configured to employ a wireless communication protocol such as Bluetooth, along with additional network interface(s) such as those employing one or more additional wireless communication protocols such as IEEE 802.11, Bluetooth Low Energy, or other local area network (LAN) or personal area network (PAN) protocols such as WiFi. In particular implementations, the communication unit is particularly suited to communicate with other communication units in devices via Bluetooth. In additional particular implementations, the communication unit is configured to communicate with devices described herein using broadcast audio over a BLE or similar connection (e.g., including a proxy connection). In still further implementations, the communication unit is configured to communicate with any other device wirelessly via one or more of: Bluetooth (BT); BT low-energy (LE) audio; broadcast, such as via synchronized unicast; a synchronized downmixed audio connection over BT or other wireless connection (also referred to as SimpleSync™, a proprietary connection protocol from Bose Corporation, Framingham, MA, USA); multiple transmission streams such as broadcast, for example, to simultaneously output different portions of an audio signal. In still further implementations, the communication unit is configured to communicate with any other device in the system 10 via a hard-wired connection, e.g., between any two or more devices.

As noted herein, controller 90 controls the general operation of the system 10, and in some cases, controls general operation of the audio system 100. For example, the controller 90 performs processes in controlling audio and data communication with additional devices, as well as audio output, signal processing, etc., at the speakers 50, 70. In addition to the general operation, the controller 90 initiates a communication function implemented in the communication module upon detecting certain triggers (or, events), described herein.

In various particular implementations, a first NF speaker 50 is configured to output audio to a left ear of a user, and a second NF speaker 50 is configured to output audio to a right ear of the user. In certain cases, NF speakers such as speakers 50A are housed in a common device (e.g., contained in a common housing), or otherwise form part of a common speaker system. For example, the speakers 50A in the backrest 40 can include in-seat or in-headrest speakers such as left/right speakers in a headrest and/or seatback portion of an entertainment seat, gaming seat, theater seat, automobile seat, etc. As noted herein, the backrest 40 can include an integral headrest and/or an adjustable headrest, and in some cases, the headrest includes the speakers 50A. In certain cases, the backrest 40 is approximately flat, slightly wrapped to envelope the user's head/back, or extends at least partially along the sides of the user's head when in the seat 20 to provide envelopment. In some cases, additional NF speakers 50B are positioned or otherwise configured to output audio primarily to the left ear or the right ear of the user. For example, an NF speaker 50B in the overhead feature 60 that is positioned above and left of the user's ear can be configured to output audio directed to the left ear of the user, while an NF speaker 50B in the overhead feature that is positioned above and right of the user's ear can be configured to output audio directed to the right ear of the user.

With continuing reference to FIGS. 1 and 2, in various implementations, the controller 90 is configured to maintain spatialization of audio output at the set of NF speakers 50 (as perceived by the user in seat 20), based on detecting a position change and/or orientation change of the user. In various implementations, the audio output is spatialized such that the acoustic signals received at the left ear of the user and the right ear of the user create a perceived acoustic source from a virtual location (vl). FIG. 1 shows three virtual locations: vl₁, vl₂, and vl₃ at distinct left-to-right positions relative to the seat 20, and FIG. 2 shows three virtual locations vl₄, vl₅, and vl₆ at distinct heights (and distances) relative to the seat 20. These virtual locations are merely illustrative of the various perceived source locations that can be produced by the system 10. As illustrated and discussed herein, these virtual locations (vl) are not associated with a location of the NF speakers 50. Further, in various implementations, these virtual locations (vl) are not associated with a location of any additional speakers (e.g., speakers 70) that are providing the audio output. In certain cases, virtual locations (vl) can be characterized such that the user in seat 20 perceives the audio output as originating from a location in space 5 that is not associated with a speaker. In other terms, the audio output is perceived as originating from the location (vl) in space 5 that is between the user and the location of at least one speaker 50, 70. In additional cases, the audio output is perceived as originating from a location (vl) in space that is separated by at least X degrees (e.g., approximately 5 degrees, approximately 10 degrees, approximately 15 degrees, approximately 20 degrees) from any speaker (e.g., NF speakers 50, speakers 70) used in producing the audio output. In various implementations, the controller 90 includes an interaural control function that provides the audio output at one or more virtual locations (vl).

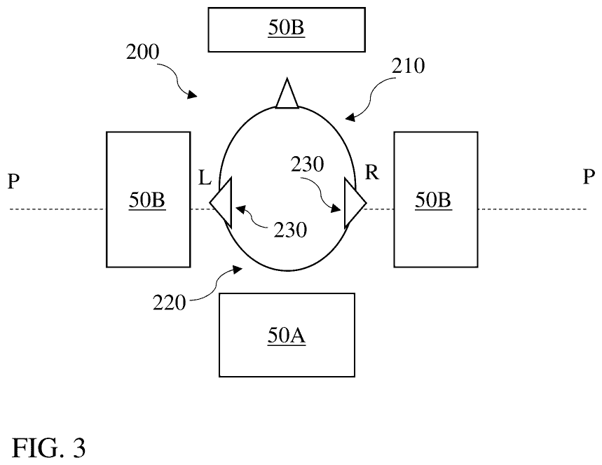

FIG. 3 is a schematic top view of a user 200 in a seat (e.g., seat 20) along with NF speakers 50A in the headrest and NF speakers 50B in the overhead feature. Speakers 50A, 50B are shown in block form in FIG. 3 as speaker elements, and can represent general locations of such elements. It is understood that speakers 50B can be located over (above) the user's head 210 (e.g., as in FIG. 2) while speakers 50A are located proximate to the back 220 of the user's head 210. In certain cases, NF speakers 50B in the overhead feature are located on both sides of the user's head as well as in front of the user. In various implementations, NF speakers 50B can be located as far forward of the user's head as a front of the space (e.g., vehicle), and in some cases, are located proximate a visor location in a vehicle. Left (L) and right (R) ears 230 are also denoted, along with a plane (P) that intersects the user's ears 230, e.g., at approximately the ear canal entrance. In further implementations, such as described herein, the seatback 40 can at least partially wrap around the user's head, e.g., the back 220 of the head, enabling speakers 50A to be angled relative to plane P.

In certain non-limiting examples, the audio output from NF speakers 50 produces a sound stage that is perceived as being in front of the first user 200 (e.g., in seat 20). In particular aspects, the sound stage includes a center image. In further aspects, the sound stage perceived as being in front of the user 200 is aligned with or forward of the user's ears, and in particular cases, in front of the user's eye position. In certain cases, the sound stage is perceived as being in front of the user 200, at eye level +/−approximately 89 degrees or less, and at a distance from the user 200 within the space 5 (e.g., within a vehicle cabin, or otherwise within a meter or two of the user). For example, returning to FIG. 2, vl₅ can be approximately aligned with the user's eye level (while the user is looking approximately straight ahead), while vl₄, and vl₆ are approximately 15-30 degrees above and below eye level, respectively. In particular implementations, the sound stage perceived as being in front of the user is perceived as being located approximately forward of the first user's ears, e.g., in front of plane P in FIG. 3. In additional non-limiting examples, the sound stage is perceived as at least partially surrounding the user, e.g., enveloping the user, and in certain cases, extending behind the first user's ears. In some examples, the audio output includes full bandwidth audio output. In addition to NF speakers 50, it is understood that additional speakers in the audio system 100 can provide additional aspects of the audio output to the user in a seating location. For example, additional speakers 70 can provide output in distinct or overlapping frequency ranges with NF speakers 50. In one example, additional speakers 70 in the system can provide a bass portion of the output to the user (e.g., a portion of the full bandwidth audio output).

In particular implementations, some NF speakers 50B that are located forward of the user's head may be employed by the controller 90 to control spatialization of the audio output as the user's head turns, e.g., when a user turns (rotates) a certain number of degrees from straight ahead. In one example, energy to NF speakers 50B forward of the user's head is modified in response to detecting user head movement that meets or exceeds a threshold (e.g., a certain number of degrees rotation from center). These forward NF speakers 50B can be used to compensate for differences in energy and/or directionality from NF speakers 50B located on either side of the user or behind the user when the head turns past a threshold, e.g., such that forward NF speakers 50B on a given side can compensate for side or rear located NF speakers 50B. In various implementations, the controller 90 adjusts energy to the NF speakers 50B, in particular, forward-located NF speakers 50B, in response to detecting the user's head turn.

In certain additional implementations, NF speakers 50B in the pillar locations (e.g., A-pillar or B-pillar) may be employed by the controller 90 to control (e.g., mitigate) acoustic reflections from the sides of a space such as the sides of a vehicle (e.g., window). For example, the system can control output from a NF speaker 50B proximate the A-pillar and/or B-pillar to mitigate acoustic reflections from a window, door, or wall of a vehicle. In particular cases, the NF speaker 50B proximate the A-pillar and/or B-pillar can be controlled for anti-reflection (or reflection canceling) output.

As noted in U.S. Pat. No. 9,967,692 (previously incorporated here by reference), in the example of a vehicle audio system, one aspect of the audio experience that is controlled by the tuning of the vehicle is the sound stage. “Sound stage” refers to the listener's perception of where the sound is coming from. In particular, it is generally desired that a sound stage be wide (sound comes from both sides of the listener), deep (sound comes from both near and far), and precise (the listener can identify where a particular sound appears to be coming from). In an ideal system, someone listening to recorded music can close their eyes, imagine that they are at a live performance, and point out where each musician is located. A related concept is “envelopment,” by which we refer to the perception that sound is coming from all directions, including from behind the listener, independently of whether the sound is precisely localizable. Perception of sound stage and envelopment (and sound location generally) is based on frequency-dependent level differences and arrival-time (phase) differences between sounds arriving at both of a listener's ears, and sound stage can be controlled by manipulating the audio signals produced by the speakers to control these inter-aural level and time differences. As described in U.S. Pat. No. 8,325,936, hereby incorporated by reference, near-field speakers and fixed speakers may be used cooperatively to control spatial perception in a vehicle audio system.

In contrast to conventional systems, the systems and approaches disclosed according to implementations herein can enable maintaining spatialization of an audio output to a user (e.g., user 200, FIG. 3) based on detecting a position and/or orientation change of that user. In particular cases, the spatialization of the audio output is controlled by the NF speakers 50. In more particular cases, spatialization of the audio output is controlled exclusively by the NF speakers 50.

The system and approaches according to various implementations can be referred to as “virtual headphones” or “virtual earphones,” such that they provide audio spatialization that a user may be accustomed to from an in-ear or on-ear wearable audio device, without such a wearable audio device. These implementations can utilize NF speakers 50 to provide the spatialized audio output that responds to detected changes in user position. In various implementations, the controller 90 detects a position and/or orientation change of the user (e.g., user 200) and adjusts the audio output at the NF speakers 50 to maintain the spatialization to user 200 based on the position and/or orientation change.

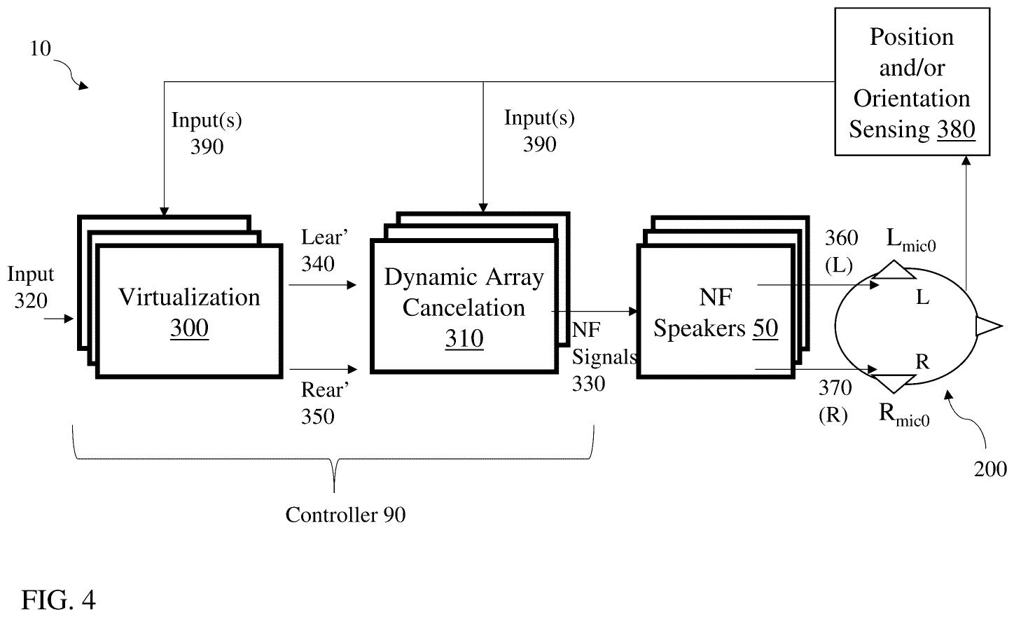

FIG. 4 is a data flow diagram illustrating aspects of the system 10, including aspects of the controller 90 that is configured to provide position-responsive spatialized audio to the user. Certain functions of the controller 90 can be executed as hardware and/or software for controlling spatialized audio output at the NF speakers 50. For example, the controller 90 can include a virtualization platform 300 and a dynamic array cancelation platform (also called a “dynamic array module”) 310 for processing input signals 320 (e.g., source audio signals) to provide near field speaker signals 330 to NF speakers 50. The dynamic array cancelation platform 310 can include an array that adjusts settings based on detected movement by the user (e.g., position and/or orientation change). It is understood that the virtualization platform 300 and the dynamic array module 310 can be collectively housed and/or operated in the controller 90, and need not be separate components. In certain cases, the virtualization platform 300 and dynamic array module 310 share one or more hardware and/or software components to execute functions described herein. In some cases, virtualization and arraying may be performed by a single module or processing block, e.g., a processing module that receives the input 320 and produces the NF signals 330 without producing intermediate signals Lₑₐᵣ′ 340 and Rₑₐᵣ′ 350. Accordingly, certain cases may not include each of a distinct virtualization platform 300 and a dynamic array module 310 but nonetheless produce a similar set of resulting NF signals 330.

In particular cases, the virtualization platform 300 converts input signals 320 to virtualized left (L_{ear′}) and right (R_{ear′}) ear signals 340, 350 configured to provide the perceived balance between the user's left and right ear for providing an audio output to a virtual location (vl). In some examples, the dynamic array cancelation platform 310 converts the virtualized left and right ear signals 340, 350, e.g., to cancel cross-talk (e.g., inter-aural cross-talk) between those signals, providing near field speaker signals 330 to NF speakers 50 that virtualize the audio source while mitigating cross-talk, e.g., inter-aural cross-talk. In additional cases, the dynamic array cancelation platform 310 can be configured to cancel or otherwise adjust cross-talk using beamforming. The NF speakers 50 then provide audio output, in particular, acoustic signals 360 for reception by the user's left ear (L) and acoustic signals 370 for reception by the user's right ear (R). In the acoustic model of the user's head, the left ear of user 200 is characterized as a left microphone (L_{mic0}) and the right ear of user 200 is characterized as a right microphone (R_{mic0}). As described herein, inputs 390 from a sensor platform 380 (e.g., compiling or otherwise receiving inputs from sensors 80) can be used to apply one or more distinct aspects of the virtualization platform 300 and/or the dynamic array cancelation platform 310 to provide adjusted acoustic signals 360, 370 to the user. For example, filter coefficients filter ranges, transfer functions, etc. can be adjusted based on detecting the position and/or orientation change of a user. Further, as described according to additional implementations where multiple users are present in a space, the acoustic signals 360, 370 from NF speakers can be adjusted based on detecting the presence of one or more additional users.

In certain implementations herein, the dynamic array cancelation platform 310 can be configured to provide adjusted acoustic signals 360, 370 to the user with limited inputs relating to user orientation. For example, the dynamic array cancelation platform 310 can be configured to provide adjusted acoustic signals 360, 370 to the user with data (e.g., from sensors 80) on one or two of yaw, pitch, or tilt of the user's head.

In particular aspects, the virtualization platform 300 includes at least one head related transfer function (HRTF) determination module for applying and/or adjusting an HRTF to the input (e.g., source) signals 320 based on a detected position and/or physical characteristic (e.g., size) of the user's head (as provided by position and/or orientation sensor platform 380). It is understood that the term “position” when used with respect to the user (e.g., head position) can include absolute position in a coordinate system (e.g., three-dimensional coordinate system), relative position (e.g., with respect to a reference location or position such as a sensor 80 and/or seatback 40), orientation (e.g., look direction or facing direction), or any combination thereof. That is, the sensors 80 and (position and/or orientation) sensor platform 380 are configured to provide an indication of the position (or, location) of the user's acoustic receptors, i.e., the left and right ears, to aid in spatializing the audio output. The HRTF determination module is configured to apply and/or adjust an HRTF to the input signals 320 based on detected change in user position (e.g., looking left or right, up or down, slouching in the seat, leaning forward, etc.). Further, the virtualization platform can include a simulated direct sound and reflected sound comparison module for estimating the direct sound (e.g., directly from NF speakers 50) received at a user's respective ears as well as reflected sound (e.g., originating from NF speakers but reflected off an intermediary surface) received at the user's respective ears. The HRTF determination module and simulated direct sound and reflected sound comparison module can be used to adjust the virtualized left (L_{ear′}) and right (R_{ear′}) ear signals 340, 350 based on detected position and/or orientation change from the sensor platform 380.

In particular cases, HRTFs can be stored in one or more profiles, which can be based on specific user characteristics and/or position/orientation/look direction of a reference user in the space 5. For example, HRTFs can be stored based on look direction, head position, and/or orientation of a reference user or a specific user in one or more profiles. Further, HRTFs can be stored for specific users based on physical characteristics such as head size, height (seated height), and/or other anatomical features. Additional aspects of HRTFs are described in U.S. Pat. No. 10,455,327 (“Binaural Measurement System”, issued Oct. 22, 2019) and U.S. patent application Ser. No. 18/325,352 (“Systems and Methods for Providing Augmented Audio”, filed May 30, 2023), each of which is herein incorporated by reference in its entirety.

In some cases, dynamic array cancelation platform 310 can be configured with a filter coefficient determination module that utilizes inputs from sensor platform 380 to apply distinct filter coefficients to the virtualized left and right ear signals 340, 350. In certain cases, the filter coefficient determination module applies filter coefficients at least partially based on a detected spacing between the user's left (L) and right (R) ears (e.g., L_{mic0}, R_{mic0}), as indicated by sensors 80. In various implementations, the dynamic array cancelation platform (or, dynamic array module) 310 is configured to adjust at least one of: isolation of the audio output to the user 200 or audio performance of the audio output to the user 200. In certain cases, there is a tradeoff between isolation of the audio output as compared with audio performance (as between distinct listeners/users), and in more particular cases, isolation between listeners/users is inversely related to the audio performance.

In any case, the controller 90 is configured to provide position-responsive spatialized audio to the user, by way of signals 360, 370 from NF speakers 50. In other terms, the controller 90 is configured to maintain a position of the virtual location (vl) of the audio output in space (e.g., as a three-dimensional coordinate or set of coordinates) in response to detecting the position and/or orientation change of the user (via position and/or orientation inputs 390). As described herein, maintaining spatialization of the audio output includes maintaining independent control of an acoustic signal 360 received at a left ear (L) of the user and an acoustic signal 370 received at a right ear (R) of the first user. In various aspects, signals sent to the ears of the user are independent of the source (channel) input 320.

In particular cases, the spatialized audio output includes full bandwidth audio output, e.g., multi-channel audio output, stereo audio output, and/or an ambisonics output. In particular cases, the position and/or orientation change of the user 200 includes at least one of: head movement (including, e.g. head rotation), body movement (including, e.g., body rotation), or seat movement (including, e.g., seat rotation), and the controller 90 maintains the full bandwidth audio output while the head rotation of the user 200 deviates from center by up to approximately 30 degrees, 40 degrees, 50 degrees, or 60 degrees. In a particular example, the controller 90 maintains the full bandwidth audio output while the head rotation of the user 200 deviates from center by up to approximately 40 degrees. Examples of body movement can include slouching, straightening the back, shifting in the seat, leaning forward/backward, shoulder roll, and/or shoulder rotation. Examples of seat movement can include seat fore/aft movement, seat up/down movement, seatback tilt, and/or headrest height adjustment. Head movement and/or rotation can be measured in degrees of yaw from the center (looking straight ahead) position, or in other terms, rotation about the vertical axis of the head, as well as roll (rotation about forward look axis), and pitch (rotation around left/right axis).

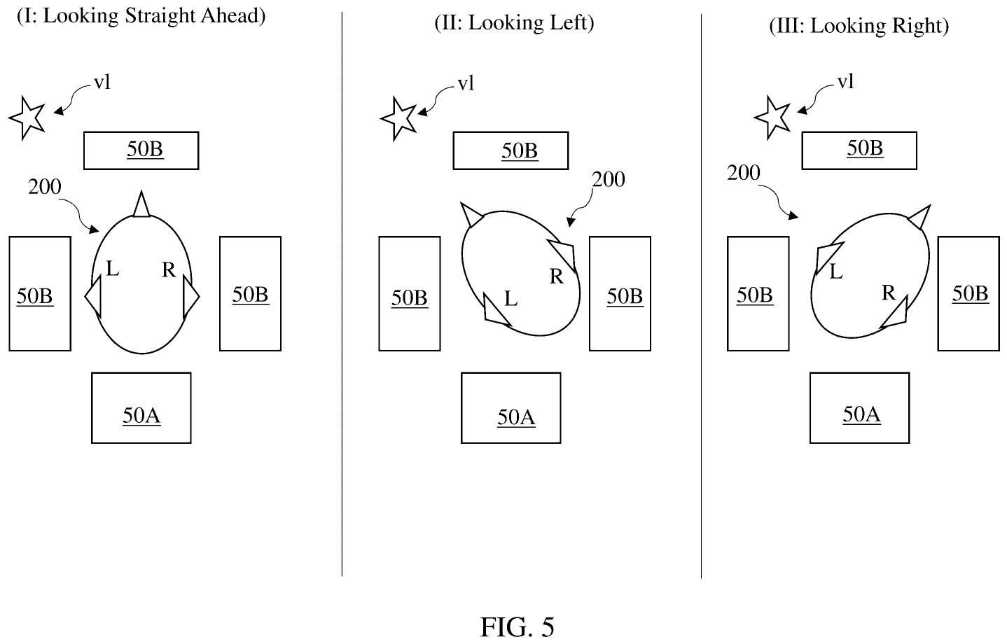

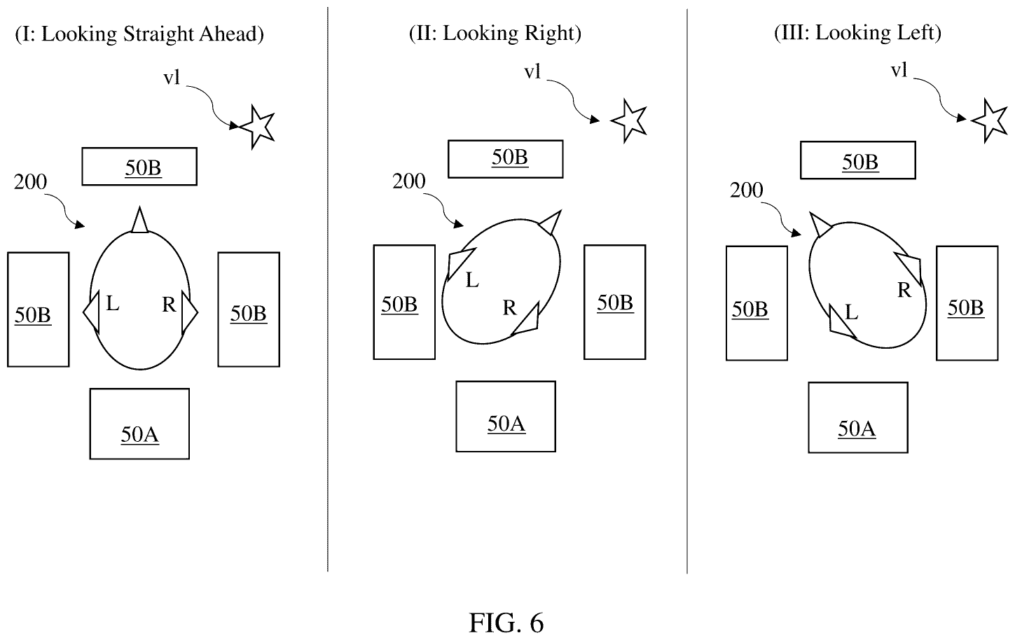

In some aspects, the spatialization of the audio output is maintained during a range of position and/or orientation changes for the user 200. FIGS. 5 and 6 illustrate respective scenarios where audio output to a virtual location (vl) is maintained during a user position and/or orientation change. FIG. 5 shows a scenario where the spatialized audio output creates a perceived acoustic source from a virtual location (vl) that is forward and left-of-center of the first user, and where the virtual location (vl) is not associated with a location of the NF speakers 50. In these cases, the controller 90 is configured such that for the left ear (L) and the right ear (R) of the user 200: I) in a first position (looking approximately straight ahead), an acoustic signal received at the left ear (L) arrives earlier than an acoustic signal received at the right ear (R); II) in a second position (looking left), the acoustic signal received at the left ear (L) arrives at approximately the same time as the acoustic signal received at the right ear (R); and III) in a third position (looking right), the acoustic signal received at the left ear (L) arrives earlier than the acoustic signal received at the right ear (R), and more so than in the first position (I). In some aspects, in the first position (I) the acoustic signal received at the left ear (L) has more high frequency content than the acoustic signal received at the right ear (R), in the second position (II) the acoustic signal received at the left ear (L) has approximately equal frequency content as the acoustic signal received at the right ear (R), and in the third position (III) the acoustic signal received at the left ear (L) has more high frequency content than the acoustic signal received at the right ear (R), and more so than in the first position (I).

FIG. 6 shows a scenario where the spatialized audio output creates a perceived acoustic source from a virtual location (vl) that is forward and right-of-center of the user 200, and where the virtual location (vl) is not associated with a location of the NF speakers 50. In particular cases, the spatialization of the audio output is maintained during a range of position and/or orientation changes for the first user such that for the left ear (L) and the right ear (R) of the user 200: I) in a first position (looking approximately straight ahead), an acoustic signal received at the right ear (R) arrives earlier than an acoustic signal received at the left ear (L), II) in a second position (looking right), the acoustic signal received at the left ear (L) arrives at approximately the same time as the acoustic signal received at the right ear (R), and III) in a third position (looking left), the acoustic signal received at the right ear (R) arrives earlier than the acoustic signal received at the left ear (L), and even more so than in the first position (I). In certain cases, in the first position (I) the acoustic signal received at the right ear (R) has more high frequency content than the acoustic signal received at the left ear (L), in the second position (II) the acoustic signal received at the left ear (L) has approximately equal frequency content as the acoustic signal received at the right ear (R), and in the third position (III) the acoustic signal received at the right ear (R) has more high frequency content than the acoustic signal received at the left ear (L), and even more so than the first position (I).

In certain implementations, the dynamic array cancelation platform 310 is configured to aid in maintaining the distinctions between arrival time and high frequency content between the left ear and right ear. This dynamic array cancelation platform 310 can be configured, e.g., to mitigate cross-talk from NF speakers 50 that could detract from the perception of the virtual location.

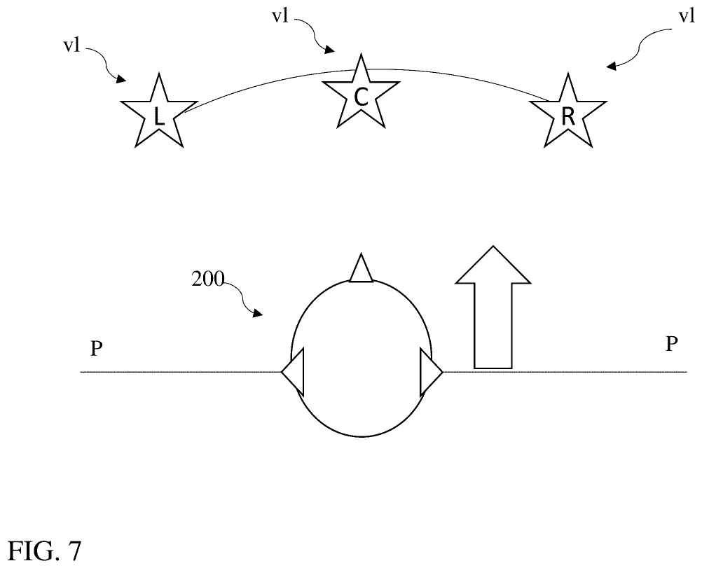

As noted herein, in various implementations the system 10 can be configured to provide virtual locations (vl) in a range of positions that deviate from the straight-ahead (or forward-facing) look direction. In one example depiction in FIG. 7, three distinct virtual locations (vl) for the audio output are depicted in distinct positions relative to the user's forward-facing look direction (as measured relative to plane (P)). Respective center (C), left (L), and right (R) virtual locations are illustrated in this example. L and R virtual locations can deviate from C by up to approximately 20 degrees, up to approximately 30 degrees up to approximately 40 degrees, up to approximately 50 degrees, or up to approximately 60 degrees. In additional implementations, virtual locations can be positioned in any number of three-dimensional locations, including at distinct heights and/or distances, around the user. In certain of those cases, the virtual locations can be positioned behind the user.

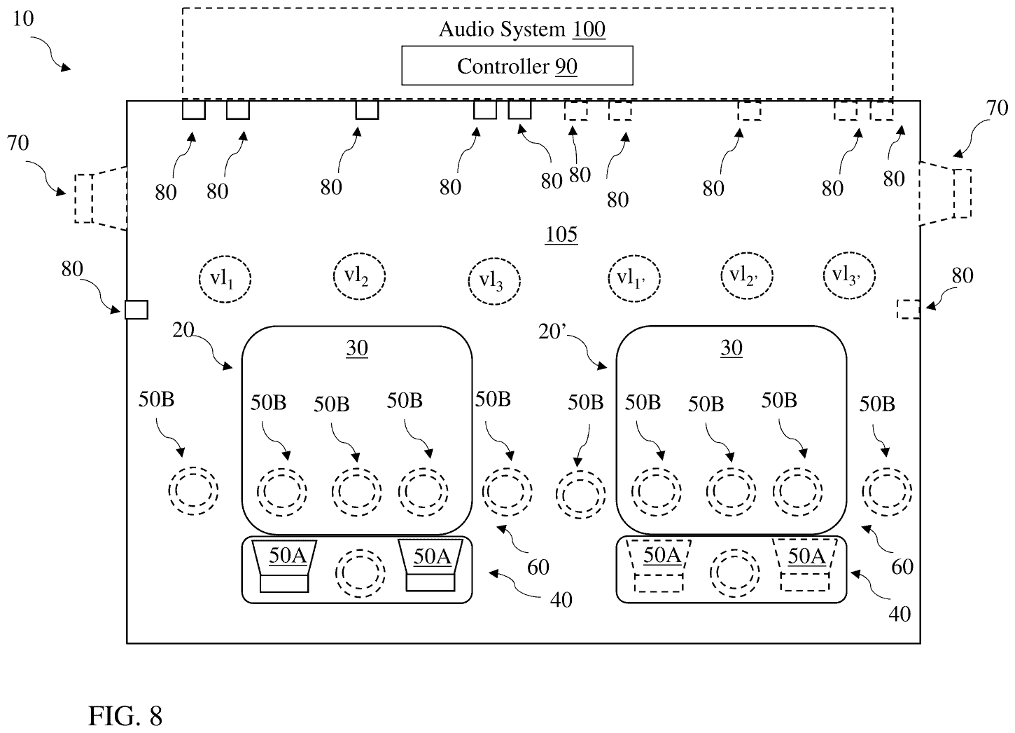

With continuing reference to FIGS. 1-7, and with particular reference to FIGS. 1-3, in various implementations the audio output is approximately consistently isolated during the position and/or orientation change of the first user 200. In particular cases, consistent isolation can include inter-seat isolation, and can also be characterized as consistently attenuated, such that perception from another location (e.g., an adjacent listening location) is minimal to negligible. Consistent isolation can be measured by one or more locations proximate a primary user (e.g., seat) location 20 and in particular examples, can be considered from the perspective of a second user in space. FIG. 8 shows an example of another implementation of system 10, depicting a second listening location (seat 20′) in a space 105. In this example, the space 105 can include a multiple listening locations, e.g., two or more listening locations, of which two (20, 20′) are depicted. In particular examples, space 105 can include a vehicle cabin, an entertainment environment (e.g., home entertainment system, theater, etc.), a gaming environment, etc. In additional cases, a gaming environment can be created or augmented with a virtual reality (VR) or augmented reality (AR) headset. In some cases, listening locations include a seat, such as seat 20. However, it is understood that listening locations need not be designated by a seat 20, and in some cases, can be standing or resting locations. In particular examples, seat 20 is considered a primary seat and seat 20′ is a secondary seat. In some such cases where the space 105 is a vehicle cabin, the primary seat 20 can be a driver's or operator's seat. However, the primary seat 20 need not include driving and/or operating equipment such as a steering wheel or controller, e.g., where the vehicle is autonomous or otherwise driver-less.

In this example, the second seat 20′ can include additional NF speakers 50 and may be positioned proximate further speakers 70. However, second seat 20′ need not have those additional NF speakers 50, which are depicted optionally in phantom. Further, as noted herein, various features of the spatialized and/or isolated audio output to the user in seat 20 do not require a second user in seat 20′. With reference to FIG. 8, as well as FIGS. 3-7, in particular implementations, the consistently isolated audio output is characterized by a difference in perception of the audio output level (or, audio output energy, or commonly referred to as volume in lay terms) at another listening location (e.g., seat 20′) by at least 5 decibels (dB) across the listening bandwidth during the position and/or orientation change of the first user 200. In particular cases, while a first user 200 in seat 20 changes position and/or orientation, the relative difference in perception of the audio output between the first user 200 and a second user 400 (e.g., in second listening location 20′) remains at least 5 dB across the listening bandwidth. In further examples, the consistently isolated audio output is characterized by a relative difference in perception of the audio output between the users (e.g., 200, 400) in seating locations (e.g., 20, 20′) of at least 10 dB, or at least 15 dB, or at least 20 dB, across the listening bandwidth during the position and/or orientation change of the first user 200. In various examples, the listening bandwidth provided by the NF speakers 50 is approximately 100 Hertz (Hz) to approximately 10 kilo-Hz (kHz). In such cases, the spatialized audio output from the NF speakers 50 is consistently isolated to the first user 200 in seat 20 such that a second user (e.g., in seat 20′) perceives minimal to negligible audibility of that spatialized output, even during movement by the first user 200.

In addition to maintaining spatialization of the audio output to the user 200 (e.g., L and R ears 230) during the position and/or orientation change of the user 200, the controller 90 can also be configured to control a stability of the audio output such that a perceived acoustic source from a virtual location is fixed relative to the system throughout the movement (e.g., position change and/or orientation change) of the user. In other terms, the virtualized source location (vl, e.g., in terms of angle and distance) is consistent throughout head (and/or body) movement of the user. In this sense, the virtual location (vl) is “anchored” in the space 5 (e.g., relative to a cabin, wall, etc.) as the user's head is moved. This stability can provide lifelike rendering that anchors an image (i.e. a speaker, a singer, or an instrument) in space 5 as though that image were physically present with the user. As the user moves, the user hears that image in a consistent place as though fixed in space 5.

With continuing reference to FIG. 8, in some cases, additional NF speakers 50A, 50B are arranged to provide audio output to a second user in seat 20′. In such cases, NF speakers 50A can be located in or around the backrest portion 40 of seat 20′, and/or in or around the overhead feature 60 proximate seat 20′. In certain of these cases, additional sensors 80 (which can be wirelessly coupled to controller 90) can be configured to detect a position of a second user in seat 20′. In particular implementations, the controller 90 adjusts the audio output to the first user 200 and/or second user (in seat 20′) based on receiving an input from sensor(s) 80 that indicates a second user is present in seat 20′. In additional cases, the controller 90 changes an operating mode of the audio system 100 based on detecting a second user in the seat 20′.

According to various implementations, the controller 90 is configured to provide a first audio output to a first user 200 (in seat 20), and also provide a second audio output to a second, distinct user (in seat 20′). In certain implementations, as noted herein, the first and second audio outputs are from the same audio source but at distinct levels (or, energy levels), effectively creating distinct volume zones between the users. In such cases, the user 200 in seat 20 can listen to the audio content at a first energy (volume) level while the user in seat 20′ can listen to the audio content at a second energy (volume) level.

In various additional implementations, the first and second audio outputs are from distinct audio sources (e.g., first and second audio sources via audio system 100, respectively). For example, the user 200 in seat 20 can listen to first audio content while the user in seat 20′ can listen to second audio content, e.g., different tracks or artists, different types of content such as music, talk/dialog, call audio, sports, etc. In such cases, the controller 90 can be configured to maintain isolation of the second audio output to seat 20′ during a position and/or orientation change of the second user in seat 20′. In certain of these cases, the second user in seat 20′ can perceive the second audio output in one or more virtual locations, e.g., vl_{1′}, vl_{2′}, vl_{3′}, which are distinct from the virtual locations (vl) for the first audio output to user 200 in seat 20. In certain cases, the range of virtual locations available to the user in seat 20′ can differ from those available to the first user 200 in seat 20 while audio output is being provided to the first user 200. That is, the range of available audio outputs to the user in seat 20′ may be based at least in part on the audio output to the first user 200 in seat 20.

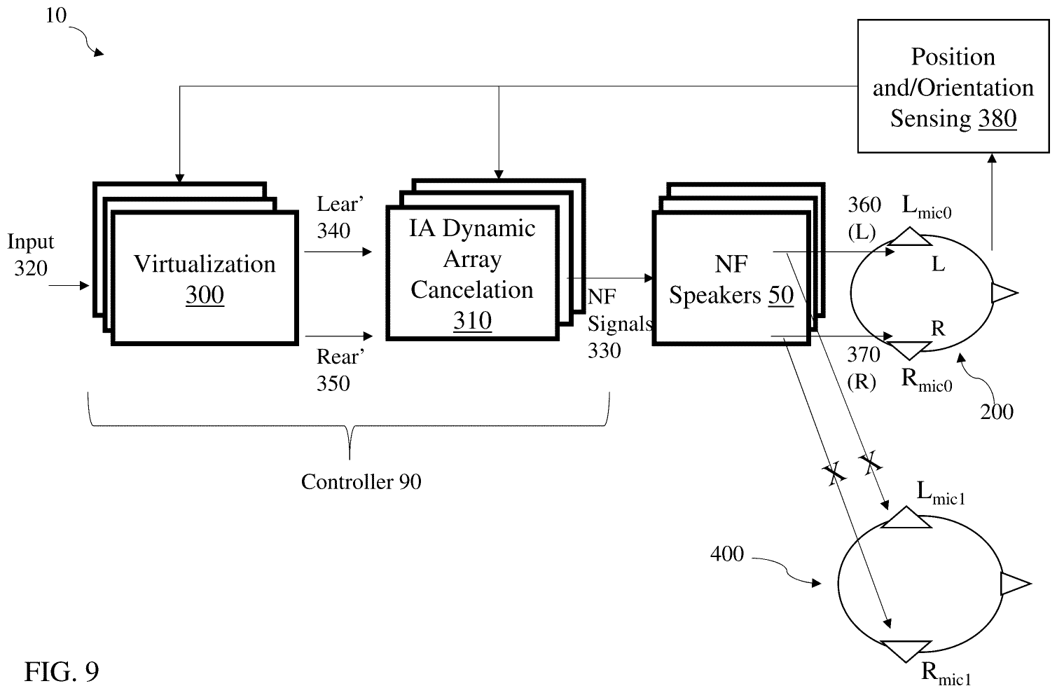

FIG. 9 shows a data flow diagram illustrating aspects of the system 10 illustrated in FIG. 8, including aspects of the controller 90 that is configured to provide position-responsive spatialized audio to the first user 200, as well as provide audio output to a second user 400. In these implementations, NF speakers 50 can include at least one NF speaker proximate to the second user 400, such as NF speakers 50A in the seatback 40 and/or speakers 50B in the overhead portion 60 above seat 20′. In these cases, the controller 90 can be configured to control spatialization of the audio output to user 200 while maintaining isolation of that output according to parameters discussed herein. Similar to the configuration in FIG. 4, in these cases, the controller 90 is configured to control the spatialized audio output to user 200 based on detected changes in that user's position and/or orientation (e.g., as indicated by sensor 80). In certain cases, the virtualization platform 300 is configured to adjust Lₑₐᵣ′ input 340 and Rear′ input 350 to dynamic array cancelation platform 310 based on the presence of a second user 400 in seat 20′. In one example, for Lₑₐᵣ′, the virtualization platform 300 enhances (e.g., maximizes) energy to the L_{mic0} while reducing (e.g., minimizing) energy to all other microphones (e.g., minimizing the R_{mic0} energy for interaural and/or other microphones in other seats such as L_{mic1} and R_{mic1} for user 400). In these cases, for Rear′, the virtualization platform 300 enhances (e.g., maximizes energy to the R_{mic0} while reducing (e.g., minimizing) energy to all other microphones in other seats (e.g., minimize the L_{mic0} energy for interaural and other microphones in other seats such as L_{mic1} and R_{mic1} for user 400).

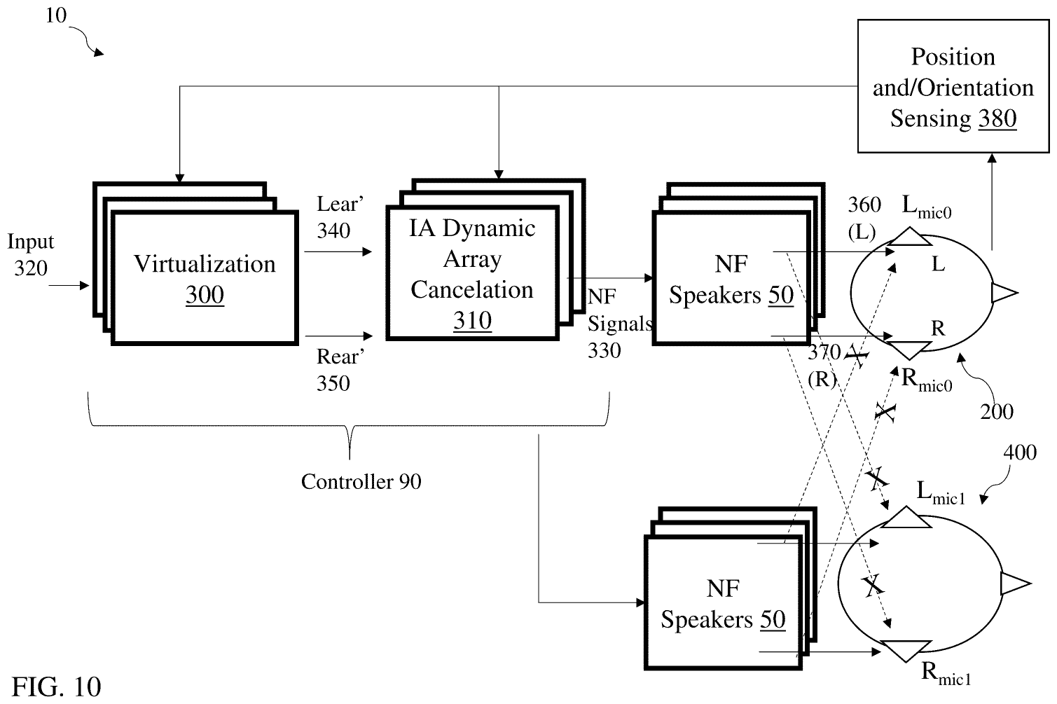

FIG. 10 illustrates another example where NF speakers 50 proximate one or both seating locations can be used to control spatialization of the audio output to user 200 and/or user 400 while maintaining isolation of that output according to parameters discussed herein (possible spatialization controls between users 200, 400 depicted in phantom as optional in certain examples). In certain cases, NF speakers 50 proximate one or both locations can be used control spatialization of audio output to users 200, 400. In some of these cases, NF speakers 50 proximate one or both users 200, 400 can be used to provide cross-car cancelation. In these examples, the NF speakers 50 proximate a second user 400 can be used to cancel residual energy arriving from the NF speakers 50 proximate the first user 200, or vice versa. In further implementations, all NF speakers 50 (and in certain cases, at least some of the additional speakers 70) can be used to cancel (or mitigate) residual energy from output to distinct users 200, 400, e.g., to maintain isolation. In certain of these cases, one or more subsets of NF speakers 50 can be configured (by placement, by orientation, by provision of NF signals 330, or by any combination of these) to avoid directing energy to a secondary seating location, e.g., NF speakers 50 proximate the first user 200 can be configured to avoid directing energy toward the second user 400, and vice versa.

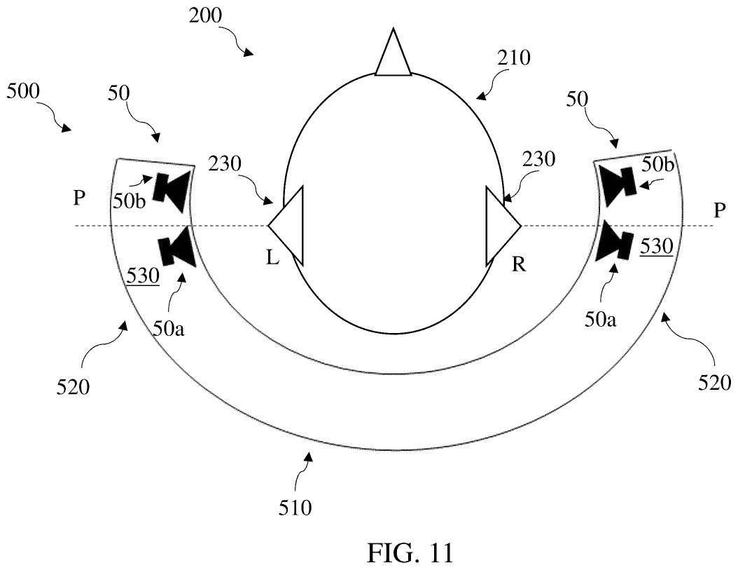

FIG. 11 shows an additional implementation of a seat 500 that can be used as part of the system 10 according to various implementations. It is understood that seat 500 is merely one non-limiting example seat according to certain implementations. As noted herein, any seat that integrates and/or benefits from NF speakers as defined herein can be used according to the various disclosed systems and approaches. For examples, seats employing flat-front headrests, angled headrests, wrapped headrests, arced headrests, one or more angles, curves, etc., can be beneficially employed with the various disclosed implementations. Various additional features of seats compatible with the disclosed systems and approaches are described herein and illustrated in further patents and publications, e.g., in U.S. Pat. No. 10,455,327 and U.S. patent application Ser. No. 18/325,352 (previously incorporated by reference herein), along with U.S. Pat. No. 10,730,423 (“Vehicle Headrest”, issued Aug. 4, 2020), and U.S. Pat. No. 11,647,327 (“Backrest Speakers”, issued May 9, 2023), each of which are entirely incorporated by reference herein.

Returning to the non-limiting example of FIG. 11, seat 500 is shown with a user 200 according to various implementations. In these implementations, the seat 500 can include a back portion 510 and at least one side portion 520 that at least partially envelopes the user 200. In certain cases, the seat 500 enables positioning of at least one NF speaker 50 to direct acoustic energy to each ear 230. In certain cases, the at least one side portion 520 includes a set (e.g., pair) of sides 530 that are positioned to align a set of NF speakers 50 such that those NF speakers 50 fire approximately directly to the user's ears. In particular cases, at least one NF speaker 50 on each side of the user's head 210 is positioned forward of the plane P that intersects the user's ears 230. In some cases, each side 530 includes a set of NF speakers 50, e.g., two NF speakers 50 in each side 530. In more particular examples, a first NF speaker 50a is located approximately at or rearward of the plane P, and a second NF speaker 50b is located approximately at or forward of the plane P, while the user is in a neutral position in the seat 500. In further examples, the NF speakers 50a, 50b are spaced such that the acoustic output from each NF speaker 50a, 50b arrives at the user's ear 230 in a time-aligned manner. In such cases, there is little or no detectable delay between arrival of the output from NF speaker 50a and NF speaker 50b to respective ears 230. In certain cases, the seat 500 can be used as part of, or in conjunction with, additional systems described herein, e.g., audio system 100 and components thereof as disclosed with respect to FIG. 1. For example, seat 500 can be part of a vehicle, entertainment system, gaming system, etc., that employs the additional NF speakers 50, controller 90, and/or audio system 100. In one example, seat 500 is a vehicle seat, and in particular cases, is a rear seat or non-driver (or non-primary) seat in a vehicle. In particular examples, the NF speakers 50 are approximately vertically aligned with the user's ears 230, e.g. at approximately the same height as the user's ears, within several centimeters (cm). In various implementations, the sides 530 are continuous with the back 510, and in particular cases, are formed of a common material. In certain cases, the back 510 and sides 530 collectively envelope a portion of the back of the user's head, and in particular cases, extend approximately 150 degrees to approximately 210 degrees (annularly) around the user's head 210.

While various implementations of the system 10 depict a controller 90 physically housed proximate a space, such as space(s) 5, 105 (FIGS. 1, 8), it is understood that the controller 90 and/or other functions and/or components of an audio system 100 can be connected with a network and/or cloud system such as a network-based source device and/or cloud computing system. In a non-limiting example, one or more devices or systems is connected to a network and/or cloud computing system via an additional device in the space 5, 105, such as a smart device. It is understood that the controller 90 and/or audio system 100 can utilize a network and/or cloud connection via an additional device. In further implementations, the audio system 10 and/or the additional device act as a source device, for example, with integrated network and/or cloud communications capabilities. In one example, the audio system 100 and/or the additional device are network and/or cloud-connected devices that runs a software program or software application (also called an “app”) configured to manage audio output to one or more devices. In certain examples, a source device sends signals to the audio system 100, e.g., a vehicle audio system, entertainment audio system, gaming audio system, etc. While particular example scenarios are described herein, the audio system 100 and/or additional device(s) can forward or otherwise transmit signals in any technically feasible manner, and the examples described herein (e.g., SimpleSync, broadcast, BT, etc.) should not be considered limiting of the various implementations.

In certain cases, controller 90 in the audio system 100 detects data for transmitting to the one or more NF speakers 50 and/or other speakers 70 to reduce detectable noise in one or more frequency bands. For example, detected data can be obtained from one or more sensors in the system 10, e.g., sensors 80 and/or additional electronics in the system 10 (e.g., sensors such as microphones, IMUs, accelerometers/gyroscope/magnetometers, optical sensors, voice activity detection systems). In some implementations, the detected data indicates at least one of: a head position of a user, an acoustic signature of noise in the space (e.g., space 5, 105), whether audio output is occurring in the audio system 100, whether the user is speaking, whether another user in the space (e.g., space 5, 105) is speaking, a noise parameter (e.g., a vehicle noise parameter), or a usage parameter (e.g., a vehicle usage parameter). In certain implementations, e.g., where sensors such as sensors 80 include microphones, those microphones can provide data to the audio system 100, including but not limited to the frequency range of sound detected for the purposes of boosting a sound management feature or further reducing noise experienced by the user in seat(s) 20, 20′. In particular examples, a vehicle noise parameter or vehicle usage parameter can include a speed of the vehicle, whether particular systems in the vehicle are engaged (e.g., HVAC), whether a window or sunroof is open, a gear in which the vehicle is operating, revolutions per minute (RPM) of the vehicle engine, a number of occupants of the vehicle, a model of the vehicle, or a seat location of one or more listeners. In various implementations, the controller 90 is configured to receive data from a central vehicle controller or a vehicle interface indicating at least one of the vehicle noise parameters or vehicle usage parameters.

As noted herein, the controller 90 is configured to deploy a set of filters to spatialize audio output to a user and/or reduce noise detected by the user. In certain implementations, the set of filters are: i) predetermined, ii) fully adaptive, or iii) a mixture of predetermined and fully adaptive. In some examples, a fully adaptive filter relies on the use of the sensors such as microphones (e.g., microphones in sensors 80 and/or proximate NF speakers 50) as an error microphone and/or a predictive model or simulation of the environment in the space (e.g., space 5, 105) to filter the audio signals. Additional details of adaptive filters in digital signal processing are included in U.S. Pat. No. 9,633,647 (Self-Tuning Transfer Function for Adaptive Filtering) filed Oct. 4, 2016, which is entirely incorporated by reference herein.

In various implementations, the controller 90 can deploy a set of filters to audio signal inputs to spatialize audio as described herein. In certain aspects, the controller 90 deploys distinct filters (e.g., specific filters and/or sub-sets of filters) to provide at least one of: i) seat-specific spatialization and/or noise cancelation settings for the audio output, ii) user-specific spatialization and/or noise cancelation settings for the audio output, iii) user-adjustable spatialization and/or noise cancelation settings for the audio output, or iv) differential user-adjustable spatialization and/or noise cancelation settings for the audio output. In still further examples, the controller includes spatialization and/or noise cancelation settings that are user-adjustable, e.g., via an interface at the vehicle control system or via an application running on a connected additional device such as a smart device.

In some aspects, such as where the system 10 is part of a vehicle, noise cancelation (NC) settings (applied by controller 90 and/or audio system 100) can be tailored to cancel road noise and/or engine noise, tire cavity and/or cabin boom noise. Further description of NC settings and noise control in vehicles is described in U.S. Pat. No. 10,839,786 (Systems and Methods for Canceling Road Noise in a Microphone Signal), filed Jun. 17, 2019, and U.S. Pat. No. 9,928,823 (Adaptive Transducer Calibration for Fixed Feedforward Noise Attenuation Systems), filed Aug. 12, 2016, each of which is entirely incorporated by reference herein.

In addition to controlling spatialization of audio output to the user with NF speakers 50, in the example where system 10 is part of a vehicle, the controller 90 can be configured to adjust NC settings to cancel or otherwise mitigate vehicle noise. In particular cases, adjusting NC settings can include applying a narrowband feedforward or feedback control to a noise signal at the NF speaker(s) 50 based on an input from a reference sensor. In some cases, the input from the reference sensor indicates an RPM level of the vehicle or a target frequency of noise in the space (e.g., where space 5 and/or 105 includes a vehicle cabin), for example, as indicated by an input from sensors 80 and/or additional microphones in the audio system 100. In certain cases, the reference sensor can include a microphone, an accelerometer (e.g., an IMU) or a strain sensor. In some additional aspects, adjusting the NC setting includes applying a broadband feedforward control to a noise signal at NF speaker 50 based on an input from a reference sensor in the space 5, 105. The reference sensor for the feedforward control can include one or more of the same reference sensors used in the narrowband NC setting adjustment, or can include distinct reference sensors. Examples of narrowband noise include engine and/or motor harmonics, noise from detection systems such as LiDAR motor(s), tire cavity resonance, cabin boom noise and/or compressor (e.g., air conditioning compressor) noise. Examples of broadband noise that the system is capable of controlling (and in some cases canceling) include road noise such as structure-borne road noise. In particular examples, tire cavity resonance and cabin boom are tonal subsets of broadband noise, even though generally classified as narrowband noise. In certain implementations, one or more portions of the system 10 are configured to focus noise cancelation on narrowband noise, enhancing cancelation within the relatively narrower band of noise (as compared with broadband cancelation).

In any case, the approaches described according to various implementations have the technical effect of enhancing spatialization of audio output and dynamic control of such spatialization for a user in an environment by utilizing near-field (non-occluding) speakers. For example, the approaches described according to various implementations provide spatialization of audio output to one or more users responsive to the user(s) movement within space. In particular cases, the approaches described according to various implementations can maintain spatialization of audio output during a position and/or orientation change of a user, and can provide consistent isolation of that audio output, e.g., to a secondary location in space. In some examples, the approaches described according to various implementations can provide spatialization of audio output from near-field speakers to mimic control conventionally found in occluding (e.g., in-ear or on-ear) headphones. In these senses, the approaches described according to various implementations can provide a sense of “virtual” headphones (or, earphones). These systems and methods also allow users in the same space to experience different audio environments without occluding (or, wearable) audio devices.

Various wireless connection scenarios are described herein. It is understood that any number of wireless connection and/or communication protocols can be used to couple devices in a space, e.g., space 5 (FIG. 1) and/or space 105 (FIG. 8). Examples of wireless connection scenarios and triggers for connecting wireless devices are described in further detail in U.S. patents application Ser. No. 17/714,253 (filed on Apr. 4, 2022) and Ser. No. 17/314,270 (filed on May 7, 2021), each of which is hereby incorporated by reference in its entirety).

The above description provides embodiments that are compatible with BLUETOOTH SPECIFICATION Version 5.2 [Vol 0], 31 Dec. 2019, as well as any previous version(s), e.g., version 4.x and 5.x devices. Additionally, the connection techniques described herein could be used for Bluetooth LE Audio, such as to help establish a unicast connection. Further, it should be understood that the approach is equally applicable to other wireless protocols (e.g., non-Bluetooth, future versions of Bluetooth, and so forth) in which communication channels are selectively established between pairs of stations. Further, although certain embodiments are described above as not requiring manual intervention to initiate pairing, in some embodiments manual intervention may be required to complete the pairing (e.g., “Are you sure?” presented to a user of the source/host device), for instance to provide further security aspects to the approach.

In some implementations, the host-based elements of the approach are implemented in a software module (e.g., an “App”) that is downloaded and installed on the source/host (e.g., a “smartphone”), in order to provide the spatialized audio output control aspects according to the approaches described above.

It is understood that the relative proportions, sizes and shapes of the system 10 and components and features thereof as shown in the FIGURES included herein can be merely illustrative of such physical attributes of these components. That is, these proportions, shapes and sizes can be modified according to various implementations to fit a variety of products. For example, while a substantially block (or rectangular cross-sectional) shaped loudspeaker may be shown according to particular implementations, it is understood that the loudspeaker could also take on other three-dimensional shapes in order to provide acoustic functions described herein.

The term “approximately” as used with respect to values herein can allot for a nominal variation from absolute values, e.g., of several percent or less. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

Though the elements of several views of the drawings herein may be shown and described as discrete elements in a block diagram and may be referred to as “circuitry,” unless otherwise indicated, the elements may be implemented as one of, or a combination of, analog circuitry, digital circuitry, or one or more microprocessors executing software instructions. The software instructions may include digital signal processing (DSP) instructions. Unless otherwise indicated, signal lines may be implemented as discrete analog or digital signal lines, as a single discrete digital signal line with appropriate signal processing to process separate streams of audio signals, or as elements of a wireless communication system. Some of the processing operations may be expressed in terms of the calculation and application of coefficients. The equivalent of calculating and applying coefficients can be performed by other analog or digital signal processing techniques and are included within the scope of this patent application. Unless otherwise indicated, audio signals may be encoded in either digital or analog form; conventional digital-to-analog or analog-to-digital converters may not be shown in the figures.

While the above describes a particular order of operations performed by certain implementations of the invention, it should be understood that such order is illustrative, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, unless otherwise noted, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

A number of implementations have been described. Nevertheless, it will be understood that additional modifications may be made without departing from the scope of the inventive concepts described herein, and, accordingly, other embodiments are within the scope of the following claims.

1. A system, comprising:
a first set of near-field (NF) speakers;
a set of sensors for detecting at least one of a position or an orientation of a first user in a first listening location; and
a controller coupled with the first set of NF speakers and the set of sensors and configured to:
adjust an audio output at the first set of NF speakers, wherein the controller is configured to maintain spatialization of the audio output to the first user based on detecting at least one of a position change or an orientation change of the first user, and
wherein the controller is configured to control the spatialized audio output to the first user with the first set of NF speakers with consideration of isolation to a second listening location.

2. The system of claim 1, wherein maintaining spatialization of the audio output includes maintaining independent control of an acoustic signal received at a left ear of the first user and an acoustic signal received at a right ear of the first user.

3. The system of claim 2, wherein the audio output is spatialized such that the acoustic signals received at the left ear of the first user and the right ear of the first user create a perceived acoustic source from a virtual location,
wherein the virtual location is not associated with a location of the first set of NF speakers, or is associated with a location of one of the first set of NF speakers, and
wherein the virtual location is perceived as originating from a location that is separated by at least 5 degrees from any speaker used in producing the audio output.

4. (canceled)

5. (canceled)

6. The system of claim 1, wherein the audio output is approximately consistently isolated during the position and/or orientation change of the first user, wherein the consistently isolated audio output is characterized by a difference in perception of the audio output at the second listening location, relative to a perception of the audio output at the first listening location, by 5 decibels (dB) or more across the listening bandwidth during the position and/or orientation change of the first user.

7. (canceled)

8. The system of claim 1, wherein the audio output produces a sound stage that is perceived as being in front of the first user, wherein the sound stage perceived as being in front of the user is perceived as being located approximately forward of the first user's ears.

9. (canceled)

10. The system of claim 1, wherein the audio output includes full bandwidth audio output, and wherein a set of additional speakers outside of the near field provide a low frequency portion of the audio output.

11. (canceled)

12. The system of claim 1, wherein the position and/or orientation change of the first user includes at least one of: head movement or rotation, body movement, or seat movement, and wherein the controller maintains the spatialization of the audio output while the head rotation of the first user deviates from center by up to approximately 40 degrees.

13. The system of claim 1, wherein the controller includes a dynamic array module configured to control a tradeoff between isolation of the audio output to the first user and audio performance of the audio output to the first user.

14. The system of claim 1, wherein the first listening location includes a first seating location and wherein the second listening location includes one of a second seating location or a standing location.

15. The system of claim 1, wherein the first set of NF speakers includes at least two NF speaker elements.

16. (canceled)

17. The system of claim 1, wherein the set of sensors includes one or both of: i) at least two sensors, or ii) at least two optical sensors.

18. (canceled)

19. The system of claim 1, wherein the controller is configured to provide the audio output from a first audio source and provide a second audio output to a second user at the second listening location from a second audio source, wherein the controller is further configured to maintain isolation of the second audio output during a position and/or orientation change of the second user.

20. (canceled)

21. The system of claim 1, wherein the controller is configured to control a stability of the audio output such that a perceived acoustic source from a virtual location is fixed relative to the system throughout the position change and/or orientation change of the user.

22. The system of claim 1, wherein the first user is located in a first listening location, and wherein the set of sensors are further configured to detect a position of a second user in the second listening location.

23. A vehicle comprising the system of claim 1, wherein the first listening location includes a first seating location in the vehicle, wherein the first seating location includes a vehicle seat having a headrest portion, wherein a portion of the first set of NF speakers are located in the headrest portion, and
wherein the second listening location includes a second seating location for a second user in the vehicle.

24. (canceled)

25. (canceled)

26. A vehicle audio system comprising:
a first set of near-field (NF) speakers for providing a first audio output to a first listening location;
a set of sensors for detecting at least one of a position or an orientation of a first user in the first listening location; and
a controller coupled with the first set of NF speakers and the set of sensors and configured to adjust an audio output at the first set of NF speakers,
wherein the controller is configured to maintain spatialization of the audio output the first user based on detecting at least one of a position change or an orientation change of the first user, and
wherein the controller is configured to control the spatialized audio output to the first user with the first set of NF speakers with consideration of isolation to a second listening location.

27. The vehicle audio system of claim 26, wherein maintaining spatialization of the audio output includes maintaining independent control of an acoustic signal received at a left ear of the first user and an acoustic signal received at a right ear of the first user,
wherein the audio output is spatialized such that the acoustic signals received at the left ear of the first user and the right ear of the first user create a perceived acoustic source from a virtual location,
wherein the virtual location is not associated with a location of the first set of NF speakers, and wherein the virtual location is perceived as originating from a location that is separated by at least 5 degrees from any speaker used in producing the audio output.

28-30. (canceled)

31. The vehicle audio system of claim 26, wherein the audio output is approximately consistently isolated during the position and/or orientation change of the first user, wherein the consistently isolated audio output is characterized by a difference in perception of the audio output at the second listening location, relative to a perception of the audio output at the first listening location, by 5 decibels (dB) or more across the listening bandwidth during the position and/or orientation change of the first user.

32. (canceled)

33. The vehicle audio system of claim 26, wherein the audio output produces a sound stage that is perceived as being in front of the first user, wherein the sound stage perceived as being in front of the user is perceived as being located approximately forward of the first user's ears.

34. (canceled)

35. The vehicle audio system of claim 26, wherein the audio output includes full bandwidth audio output.

36. The vehicle audio system of claim 26, wherein a set of additional speakers outside of the near field provide a low frequency portion of the audio output, wherein the position and/or orientation change of the first user includes at least one of: head movement or rotation, body movement, or seat movement, and wherein the controller maintains the spatialization of the audio output while the head rotation of the first user deviates from center by up to approximately 40 degrees.

37. (canceled)

38. The vehicle audio system of claim 26, wherein the controller includes a dynamic array module configured to control a tradeoff between: isolation of the audio output to the first user, and audio performance of the audio output to the first user.

39-42. (canceled)

43. The vehicle audio system of claim 26, wherein the controller is configured to:
provide the audio output from a first audio source and provide a second audio output to a second user at the second listening location from a second audio source,
maintain isolation of the second audio output during a position and/or change of the second user, and
control a stability of the audio output such that a perceived acoustic source from a virtual location is fixed relative to the system throughout the position change and/or orientation change of the user.

44. (canceled)

45. An audio system comprising:
a first set of near-field (NF) speakers proximate a first listening location;
a second set of NF speakers proximate a second listening location;
a set of sensors for detecting at least one of a position or an orientation of at least one user in the first listening location or the second listening location; and
a controller coupled with the first set of NF speakers, the second set of NF speakers, and the set of position sensors,
wherein the controller is configured to control a spatialized audio output at one or both sets of the NF speakers, wherein the spatialized audio output is approximately consistently isolated during movement by a first user at the first listening location with consideration of isolation to the second listening location.

46. The audio system of claim 45, wherein the consistently isolated audio output is characterized by a difference in perception of the audio output at the second listening location, relative to a perception of the audio output at the first listening location, by 5 decibels (dB) or more across the listening bandwidth during the position and/or orientation change of the user in the first listening location, and
wherein the controller is configured to maintain spatialization of the audio output based on detecting at least one of a position change or an orientation change of the user in the first listening location.

47. (canceled)

48. The audio system of claim 45, wherein maintaining spatialization of the audio output includes maintaining independent control of an acoustic signal received at a left ear of the user in the first listening location and an acoustic signal received at a right ear of the user in the first listening location,
wherein the audio output is spatialized such that the acoustic signals received at the left ear of the user and the right ear of the user create a perceived acoustic source from a virtual location, and
wherein the virtual location is not associated with a location of the first set of NF speakers.

49. (canceled)

50. (canceled)

51. A vehicle comprising the audio system of claim 45, wherein the first listening location includes a first seat in the vehicle and wherein the second listening location includes a second seat in the vehicle.

52. (canceled)

53. (canceled)

54. An entertainment system or a gaming system comprising the audio system of claim 45.

55. (canceled)
